(19) United States
(12) Patent Application Publication
(10) Pub. No.: US 2024/0121083 A1
(43) Pub. Date: Apr. 11, 2024

(54) Secure restoration of private key

(71) Applicant: Die Unternehmensgefährten GmbH, Bremen (DE)

(72) Inventors: Nick LONDON, Bremen (DE); Patrick LONDON, Bremen (DE)

(73) Assignee: Die Unternehmensgefährten GmbH, Bremen (DE)

(21) Appl. No.: 18/307,783

(22) Filed: Apr. 26, 2023

(30) Foreign Application Priority Data
Apr. 27, 2022 (DE) 102022110139.8

(51) Int. Cl. H04L 9/08; H04L 9/30

(52) U.S. Cl. CPC H04L 9/0861; H04L 9/30

(57) ABSTRACT

“The invention provides a secret key management method, a secret key management device and electronic equipment, relates to the technical field of data management, and can solve the technical problem that a private key stored by a user side is difficult to find out after being lost, so that inconvenience is brought to the user to use the private key. The method comprises the following steps: combining a public key of a provider server with a private key of a user side through a public key encryption algorithm to generate a first key, and performing symmetric encryption on the private key of the user side by using the first key to obtain a first ciphertext; combining the public key of the third-party server with the private key of the user side through a public key encryption algorithm to generate a second key, and performing symmetric encryption on the private key of the user side by using the second key to obtain a second ciphertext; and sending the first ciphertext to the third-part server, and sending the second ciphertext to the provider server.”

### TECHNICAL FIELD

The invention disclosed herein relates to computer-implemented encryption techniques.

### BACKGROUND

Cryptography deals with the secure encryption of data and is applied in numerous fields of technology, in particular in the field of message transmission and numerous other computer-implemented mechanisms. In principle, encryption methods are applied to any form of data that can be represented digitally.

In cryptography, a distinction is made between symmetric and asymmetric keys. In the case of symmetric encryption, the same key is used to encrypt data—a file or a stream—whereas in the case of asymmetric encryption a key pair consisting of a private key and a public key is used. The public key is used exclusively for encryption, the private key for decryption. The public key can therefore be made generally available to enable others to encrypt data for a recipient, which is to say the owner of the private key. The private key is to be protected by its owner from access by others. The private key can moreover also be used to sign off on data. Signing off does not encrypt the data; however, a recipient of such data can use the associated public key to check whether the signature is valid—in the event that the data has been modified after signing off, then the signature is no longer valid.

A symmetric key must usually be transmitted in advance between communicating parties to enable encryption on the one hand and decryption on the other. This transmission poses a risk for the parties inasmuch as the key must be kept secret from third parties and can be copied without notice during transmission. This disadvantage does not apply to asymmetric keys inasmuch as the private key is not disclosed and the public key can be generally known.

To prevent access to the private key by third parties, it can in turn be protected by a symmetric key—for example, a password—or another asymmetric key. However, if the additional key is lost—for example, if the password is forgotten—the original private key cannot be restored according to the current state of the art, which means that the user loses access to relevant documents or the ability to identify themselves or sign off on documents.

To protect a private key from unauthorized access, the private key can be transferred to a third party for safekeeping. In the event that the key is transmitted in unencrypted form, the third party can then sign off on documents on behalf of the key holder or decrypt data that has been encrypted to the key holder. If the transmission is carried out as described here above, with an additional password or alternatively a key, there remains the problem that the key cannot be restored if the key is lost.

A non-encrypted storage of private keys, in particular with third parties, is associated with elementary risks. On the other hand, password-supported security of these private keys is associated with equally great risks against the background of the risk of loss of the key.

The invention disclosed here is based on the task of securing private asymmetric keys against such loss while avoiding the above-mentioned risks.

Abstract

Embodiments of the invention relate to methods for securing a private key of a first client, comprising: the request made by the first client of a public key of a first server; the generation by the first client of a symmetric key from the private key of the first client and of the public key of the first server, the encryption of the private key of the first client with the symmetric key, and transmission of the encrypted private key of the first client to a second server; and storage by the second server of the encrypted private key of the first client.

Further embodiments of the invention relate to systems for securing a private key of a first client, comprising: a client, a first server, and a second server; wherein the client is set up to request a public key of the first server; wherein the first server is set up to transmit the public key of the first server to the client; wherein the client is further set up to generate a symmetric key from the private key of the client and the public key of the first server, and to encrypt the private key of the client with the symmetric key, and to transmit the encrypted private key of the client to a second server; and wherein the second server is set up to store the encrypted private key of the client.

Embodiments of the invention further relate to computer-readable media having commands stored thereon which, when executed by one or more processors, execute any of the foregoing methods.

Further embodiments of the invention are apparent from the appended claims.

### BRIEF DESCRIPTION OF THE DRAWINGS

FIG. 1 shows a method according to the invention for securing a private key of a client.

FIG. 2 shows a method according to the invention for restoring a private key of a client.

FIG. 3 shows a method according to the invention for replacing a private key of a client.

FIG. 4A shows a method according to the invention for applying a password to a private key of a client.

FIG. 4B shows a method according to the invention for restoring a private key of a client by means of a password.

FIG. 4C shows a method according to the invention for replacing a password.

FIG. 5 shows a method according to the invention for authenticating a client using a server.

FIG. 6 shows a method according to the invention for authenticating a client by means of another server.

FIG. 7 shows a method according to the invention for authenticating a client based on one of the methods shown in FIG. 5 and FIG. 6.

FIG. 8 shows a method according to the invention for accessing a private key of a client.

### DETAILED DESCRIPTION

The methods described here are preferably executed by one or more clients and/or one or more servers. A client is, for example, a mobile device—smartphone, notebook or the like—or also a stationary computer. In a similar manner, a server can also be a mobile or stationary computer. Alternatively, however, clients and/or servers may be configured as software processes that run on different computers or even on the same computer. Furthermore, a client may simply be a user who executes, by means of software, the steps of a client disclosed herein.

The client or clients communicate with a first server and a second server, which are technically separated from each other and cannot communicate with each other or access each other's data. Such a separation may be implemented, for example, by server processes running on different machines, wherein the machines do not have any physical contact with each other at all and are not able to communicate with each other, for example, by means of a network connection or by other means.

Alternatively, the separation of the two servers can be achieved by operating the servers on two networks, wherein contact from one of the two networks is always denied by the other network, for example through the use of a network firewall.

Another alternative comprises operation of the servers on physically separate networks such that a direct information exchange is physically precluded. By way of example, the first server may be accessible via the Internet, however the second server may be part of a campus network or local area network that is not accessible via the Internet.

Another alternative comprises operation of the two servers within the same network, wherein the servers are however configured in such a way that they always reject connections from the other server, for example, by using a system-level firewall or an application firewall.

A direct contact between the second server and the first server may however be enabled despite the described separation of the servers, however such a direct contact is subject to strict restrictions, since both parties have data that the other party is generally not allowed to obtain when using the embodiments disclosed herein: this includes, respectively, the private key of the first server and the private key of the client encrypted with the symmetric key. This restriction can be implemented making use of different approaches. A first approach comprises the requirement to connect the two servers physically and temporarily, for example, by requiring a user to establish a direct wired connection or other hardware interface. A second approach comprises that any access between the two servers is only allowed if the space between the two servers does not exceed a specified maximum distance, for example, less than one meter or within a configurable distance. A third approach comprises configuring both servers in such a manner that they automatically shut down all other connections for the duration of a connection between the two servers, for example, communicating only over a serial port and shutting down their network stacks. The servers may be configured in such a manner that they can only establish either a connection to one another or a connection to other addresses and parties. The approaches can be combined with each other and/or supplemented by further authentication measures.

A further approach for restricting contact between the two servers can be achieved through the implementation of a further server, by way of example, using a so-called jump host. This server is configured in such a manner that it can communicate with both the first server and the second server. In this approach, the first server and the second server are configured in such a manner to recognize and accept connections from the further server. Detection of the further server by the first server and the second server may be achieved by recognition of a network address and/or technical identification and/or authentication methods. The further server serves as a packet filter between the first server and the second server and ensures that only those communications between the first server and the second server that are provided between the first server and the second server, in the context of the described methods, are possible. The filtering of packets may be carried out, for example, using deep packet inspection. A variant of the further server comprises the implementation of said server as a so-called jump host as part of a demilitarized zone; this may be combined with the first or second approach described above. Another variant comprises the use of at least two servers which are connected with one another with one or a plurality of data diodes; this can be combined with all the described approaches.

The described possibilities of restricting communication between servers and allowing communication only when taking specific precautions can be combined with all embodiments described below, without it necessarily being explicitly mentioned each time.

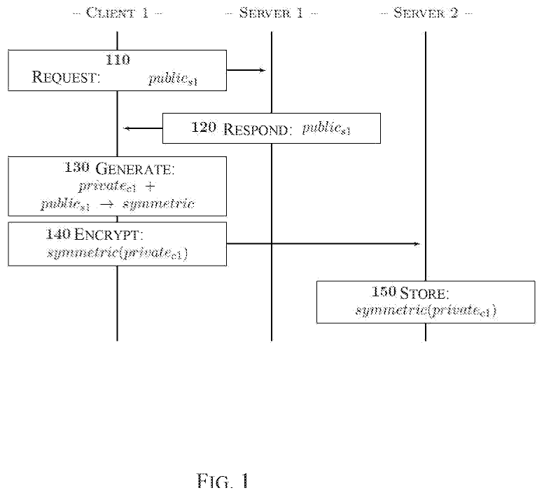

FIG. 1 shows a method 100 for securing a private key of a client (Client 1). For this purpose, the client communicates separately with a first server (Server 1) and a second server (Server 2).

In step 110, the client requests a public key (publicₛ₁) from the first server. This can be carried out, as shown in FIG. 1, by a request sent directly to the first server using an appropriate protocol, for example using HTTPS/TLS/SSL or other network protocols. Alternatively, the client may, however, also request the public key of the first server from other sources, for example, from a certificate authority (CA), in the context of a public key infrastructure (PKI) that manages and certifies public keys to allow third parties to access and/or verify a public key. In step 120, the first server transmits its public key in response to the request. This step may also alternatively be carried out by a certificate authority. As a further alternative, the request and also the response may be carried out as shown, wherein the first server retrieves its public key on its own from a certificate authority. As a further alternative, in response to the request, the first server may verify whether it already has a public key and, if this is not the case, it may generate a new asymmetric key pair and transmit a public key of said key pair to the client.

In a particular embodiment, the first server may hold a respective public key for different clients. In this embodiment, the client transmits an identifier of this client with their request in step 110. On the server side, this identifier is used to look up the corresponding public key or to generate a new asymmetric key pair for this client and store it with the identifier.

In step 130, the client generates a symmetric key from the public key of the first server (publicₛ₁) and from a private key of the client (private_{c1}). This comprises, for example, using a key derivation function (KDF). Such a key derivation function may have the property of generating the same result from the public key of a first key pair and the private key of a second key pair as from the private key of the first key pair and the public key of the second key pair.

In one embodiment, step 130 may additionally comprise the use of an oblivious pseudo-random function (OPRF) to additionally make the symmetric key dependent on information stored on a further server. For this purpose, the client masks the symmetric key by means of a random number that is only used once and transmits the result to the further server. The further server performs an operation making use of the information stored on the further server and the masked key that has been transmitted and sends the result back to the client. The client unmasks the response from the further server using the random number that is only used once. The masking operation, as well as the server operation, is set up such that the result is always the same, regardless of the random number used. An example of such an OPRF is Blind RSA Signature.

This method can be repeated with as many further servers as may be desired. One of the further servers can be the second server. If this embodiment is used, the result of the OPRF is used as symmetric in the following steps. This embodiment may be combined with any of the embodiments described below without being explicitly mentioned each time. This applies, in particular, to steps 240, 350, 497, 760, and 830 of the methods described below. The only pre-condition is that the client must always perform the OPRF function each time after obtaining (steps 240, 350, 760, and 830) or decrypting (step 497) the symmetric key.

In step 140, the client encrypts their private key with the symmetric key; the result of this encryption is referred to here as symmetric (private_{c1}), and it is transmitted to the second server with the request to store it. Such a Request or demand may additionally include an identifier of the client, such as, for example, the already described identifier of the client, this in order to enable the second server to store the encrypted private key of the client under this identifier and to be able to look it up later using the identifier. Alternatively, the second server may itself generate an identifier for the client, for example, based on an address from which the client accesses the second server. As a further alternative, this access or request may include an authentication of the client which requires the specification of an identifier and a password; in the case of this alternative, the transmitted encrypted private key may simply be stored under a user account with the second server. The second server stores the encrypted private key in step 150.

To conclude, the client deletes the symmetric key. Preferably, the method 100 may include a further step in which the client also deletes the encrypted private key of the client.

The method 100 provides a secure approach to storing a private key of a client. After application of the method 100, the first server only has its own private and public keys and is not able to generate the symmetric key required to decrypt the encrypted private key of the client from them. In addition, as explained, there is no way for the first server to retrieve the encrypted private key of the client from the first server. Likewise, the second server has no way to access the private key of the client. It is indeed true that this key is stored in encrypted form on the second server. However, as will be shown, to decrypt this key, either the symmetric key, or the private key of the client and the public key of the first server, or the public key of the client and the private key of the first server, is/are required. The second server does not have access to the data required to decrypt the encrypted private key of the client.

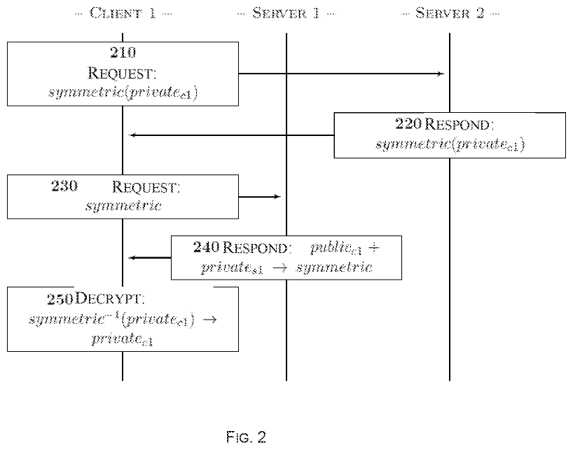

FIG. 2 shows a method 200 for restoring the private key of the client after, as explained with respect to FIG. 1, said key has been stored on the second server.

In step 210, the client sends a request to the second server to obtain the encrypted private key of the client. The sending of this request may comprise the transmission of an identifier and/or password or other authentication measures. In this way, the second server may verify the identity of the client and/or identify the encrypted private key of the client among a plurality of such keys, namely, by way of example, based on the identifier that has been transmitted. Identification of the client by other means, such as by their address or other common authentication mechanisms, is however also possible.

In step 220, the second server responds with a transmission of the requested encrypted private key of the client.

In step 230, the client requests the symmetric key from the first server. This may be undertaken in the sequence shown in FIG. 2. In particular, the client may perform step 230 only if steps 210 and 220 have been successful. Alternatively, the client may still perform step 230 before step 210 or may perform step 230 between steps 210 and 220, or generally independently of steps 210 and 220.

In step 240, the first server responds to the request of the client. This involves the generation of the symmetric key from the public key of the client and the private key of the first server. The possibility to generate a symmetric key from the private key of a first key pair and the public key of a second key pair that is identical to a symmetric key generated from the public key of the first key pair and the private key of the second key pair is ensured by the KDF. Examples of a corresponding implementation are Diffie-Hellman key exchange, Menezes-Qu-Vanstone (MQV), or hash MQV (HMQV). As an alternative to step 240, the first server may have already generated and/or stored the symmetric key in advance and merely retrieves it. The first server hereinafter transmits the symmetric key to the client. In certain embodiments, the client may transmit an identifier of the client with their request, which identifier the first server uses to look up or store the symmetric key.

In step 250, the client decrypts the encrypted private key of the client using the symmetric key; the result of this operation is shown in FIG. 2 as symmetric⁻¹ (private_{c1})→private_{c1}.

In one embodiment, the requests of steps 210 and 230 and their responses in steps 220 and 240 may be subject to the use of one or a plurality of one-time passwords which are generated by the respective servers and which are transmitted to the client by means of a previously agreed-upon path, by way of example, by means of a predefined further device of a user of the client.

As a result, method 200 allows access by the client to their private key in the event that the private key has been lost or deleted in the first place after its use. Since this requires data from two different parties—the first and second servers—each of which is insufficient to decrypt the private key on their own, the method enables a secure restoration of a private key.

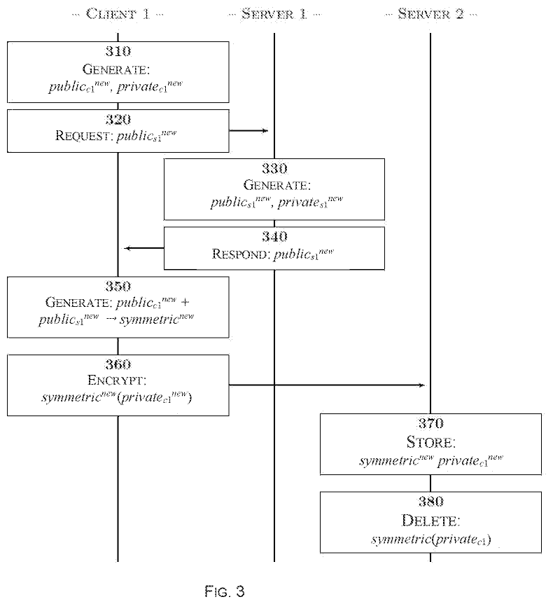

FIG. 3 shows a method 300 for replacing/renewing a private key of a client. The method 300 may be carried out after any of the previously described methods with the goal of replacing keys used over a specific period of time.

In step 310, the client generates a new asymmetric key pair, the private key of which is referred to herein as private_{c1}^{new}, and the public key of which is referred to as public_{c1}^{new}. The generation of these keys may comprise the registration of the key pair in a public key infrastructure such that the new public key can be retrieved and/or verified by third parties.

In step 320, the client sends a request for a public key of the first server to the first server. As elucidated with respect to steps 110 and 120 of method 100, this step is optional inasmuch as the client may alternatively obtain a public key of the first server from a certificate authority. The request may however also request in a dedicated manner that the first server generate a new key pair for this client, by way of example, inasmuch as the client is coming into contact with the first server for the first time or because the public key of the first server would also need to be renewed due to prolonged use (or non-use) of these keys.

In step 330, the first server generates a new key pair, the public key of which is referred to here as public_{c1}^{new} and the private key of which is referred to as privatesₛ₁^{new}. This step is carried out only if request 320 specifically requests the first server for the regeneration of the key pair.

In step 340, the first server transmits the new public key of the first server to the client.

In step 350, the client generates a new symmetric key (symmetric^{new}) from the new private key of the client and the new public key of the first server using the KDF explained earlier.

In step 360, the client encrypts their new private key with the new symmetric key and sends the result symmetric^{new}(private_{c1}^{new}) to the second server.

In step 370, the second server stores the encrypted new private key of the client.

In step 380, the second server deletes the old encrypted private key of the client. As noted, this step may be omitted in certain embodiments. This step may be delayed by a predetermined amount of time after step 370. In this way, data that was still encrypted with the old public key may be reconstructed.

The method 300 may be triggered by a user input in one embodiment. Alternatively, the method may be executed at regular preset intervals to repeatedly generate and store the newly encrypted private key of the client. Preferably, the length of such an interval may be based on the period of time that would theoretically be required to crack the symmetric key given the technical equipment and given the technical characteristics of the symmetric key (its length); the interval may, for example, be set at an interval that comprises only a certain fraction (half) of said period of time.

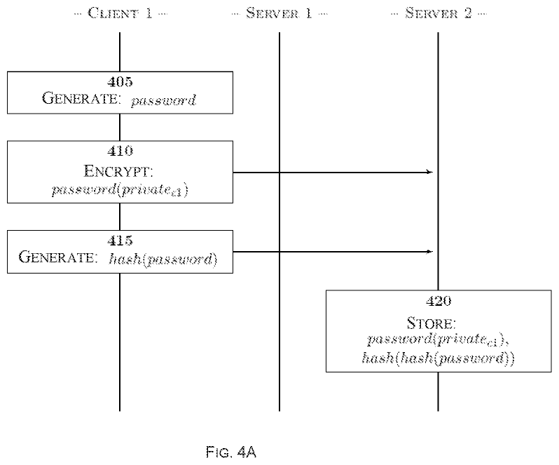

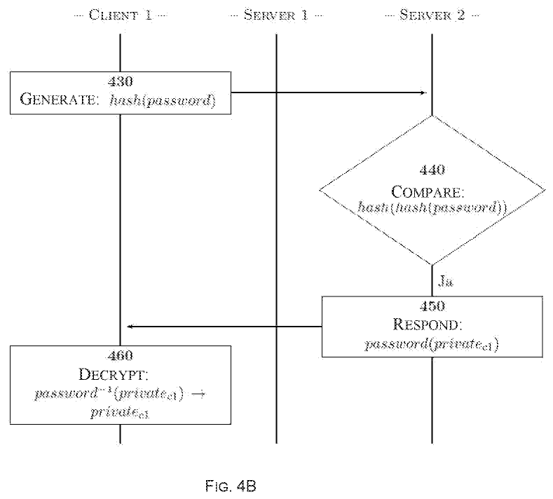

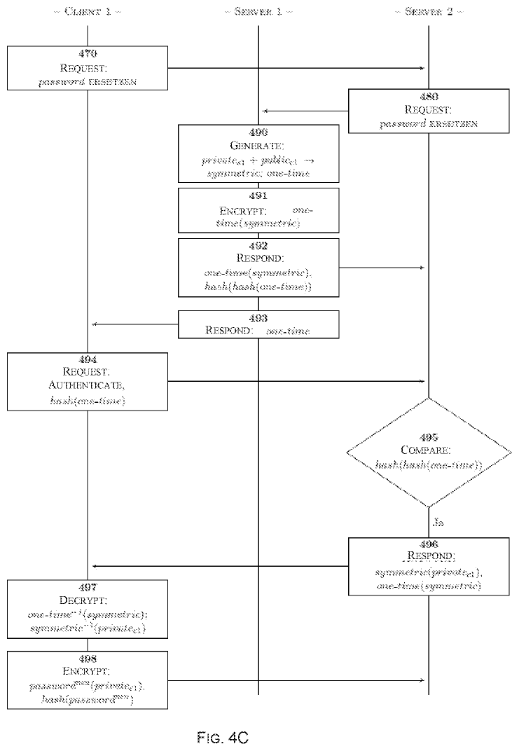

FIG. 4A shows a method 400A for the use of a password to a private key of a client. This method provides a possibility to a user to access their private key independently of a particular client. In particular, the user can access their private key using a password of their own choosing. Encryptions with a “password” use this password as a symmetric key or generate such a key with the password as an initial value (seed key).

In one embodiment, the method 400A presupposes that the steps of the method 100 have already been carried out, in such a way that a symmetric key already exists and the private key of the client encrypted with the symmetric key has been stored by the second server.

In this embodiment, the method 400A comprises a step 405 in which the client generates a password. The password may be based on a user input or may be generated automatically. The password may be identical to a password used by a user of the client to authenticate and/or log in to the client.

In step 410, the client encrypts their private key with the password and transmits the private key encrypted with the password to the second server. Unlike what is shown in FIG. 4A, the transmission may occur later, by way of example, when performing step 415.

In step 415, the client generates a hash value from the password using a hash function and transmits the hash value to the second server. In one embodiment, step 415 may transmit both the client/user private key encrypted with the password and the hash value of the password to the second server. If applicable, the client may further transmit an identifier of the user or client. The client may simultaneously transmit their private key encrypted with the symmetric key.

In step 420, the second server stores this data, wherein, in turn, in the case of the transmitted hash value, another hash value is generated from it and this hash value is stored. The client and second server preferably use the same hash function. Alternatively, different hash functions can be carried out, by way of example, the hash function sha512 on the client side and bcrypt or scrypt on the side of the second server. The data is stored together with the password-encrypted private key of the client transmitted in step 410 and, if applicable, the symmetric key-encrypted private key of the client already stored in method 100. This association may, if applicable, be undertaken based on the identifier that has been transmitted or on the basis of the client or user (corresponding authentication or address).

FIG. 4B shows a method 400B for restoring the private key of a client or user using a password. The method presupposes that method 400A has already been carried out and that the second server has both the private key of the client encrypted with the symmetric key and the private key of the client encrypted with the password. The client 1 shown in FIG. 4B may be the same as or different from the client shown in FIG. 4A.

In step 430, the client generates a hash value of the password previously used or displayed for this purpose by the client or by a user of the client, this while making use of the hash function that had already been used in step 410 of method 400A. This hash value is transmitted to the second server, possibly with an identifier of the client or user, or—as in the case of the accesses to the second server explained previously—while making use of known authentication measures. This transmission may take the form of a request asking the second server to transmit the private key of the client encrypted with the password.

In step 440, the second server generates a hash value of the hash value transmitted in step 430, making use of the hash function that had already been used in step 420 of method 400A, and compares said hash value to the hash value of said client or user stored in step 420 of method 400A. If appropriate, the second server may retrieve the stored hash value of the client/user based on an identifier of the client/user transmitted in step 430.

In step 450, in response to step 430, the second server transmits the private key of the client encrypted with the password to the client.

In step 460, with the password they already know, the client or user decrypts the password-encrypted private key that has been transmitted.

FIG. 4C shows a method 4000 for replacing a password. The method 4000 presupposes that the condition created by the method 400A and the method 100 exists, which is to say, that the private key of the client is stored in different encryptions on the second server: a first encryption is based on the symmetric key, and at least one other encryption is based on a password. As explained earlier, the symmetric key can be reconstructed by combinations of private and public keys of the client and the first server. This mechanism cannot be carried out for the password, since the password is not derived from asymmetric keys and therefore cannot be replaced without the client losing access to their private key. Method 4000 solves this problem and allows the password to be restored.

In step 470, the client requests the second server to replace their password. In one embodiment, the client may use this request to transmit their identifier to put the second server in a position to retrieve the password for this client.

In step 480, the second server passes the request of the client to the first server, again possibly including an identifier of the client. Additionally or alternatively, the second server may transmit a public key of the client.

In step 490, the first server generates the symmetric key for the client or retrieves a copy of that key stored for this client. Moreover, the first server generates a one-time password; this may itself be a symmetric key or used as one.

In step 491, the first server encrypts the symmetric key with the one-time password; the result is referred to as one-time (symmetric).

In step 492, the first server transmits the symmetric key encrypted with the one-time password as well as a hash value of the one-time password to the second server using the hash function already used in step 410 of method 400A. This step is preferably carried out using appropriate restrictions to prevent the unencrypted symmetric key from being released. The second server generates a hash value of the transmitted hash value making use of the hash function that was already used in step 420 of method 400A and stores the hash value for further use.

The communication between the first server and the second server in steps 480 and 492 is preferably carried out using the approaches described for restrictions between connections between the two servers.

In step 493, the first server communicates the one-time password to the client.

In step 494, the client requests the second server to authenticate the client using a hash value of the one-time password. For this purpose, the client transmits this hash value and, if applicable, the identifier of the client. Here too, the same hash function that was already used in step 410 of method 400A is used.

In step 495, the second server compares the double hash values obtained in step 493 and step 494; in the case in which only a single hash value was transmitted, the second server generates the double hash value on its own, using the same hash function already used in step 420 of method 400A.

In step 496, the second server responds to the client by transmitting the private key of the client encrypted with the symmetric key stored in step 150 of method 100 and the symmetric key encrypted with the one-time password provided to the second server by the first server in step 492. This transmission is subject to the condition that the values compared in step 495 are identical.

In step 497, the client decrypts the symmetric key encrypted with the one-time password and uses the symmetric key to decrypt the private key of the client encrypted with the symmetric key.

In step 498, the client encrypts their private key with a new password (password^{new}). This new password can, for example, be generated as a random value or it can be determined using user input. The client moreover generates a hash value of the new password and transmits the encrypted private key and the hash value to the second server, which second server stores both values; in the case of the hash value, the second server preferably stores a double hash value of the password. Step 498 and subsequent storage by the second server are analogous to steps 410 and 420 of method 400A. The stored hash value of the old password may be deleted, optionally after waiting for a predetermined period of time.

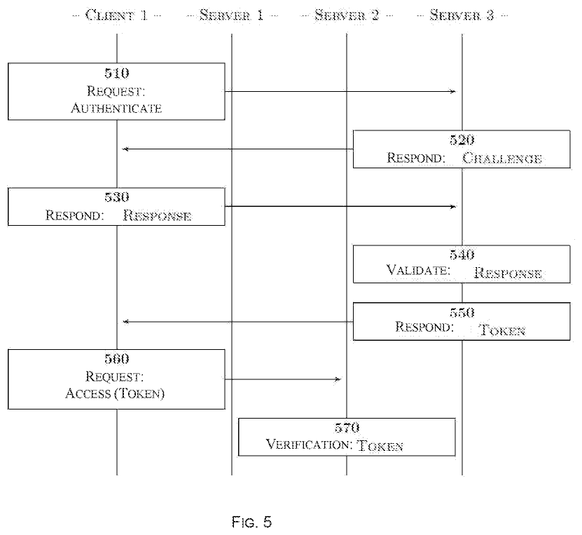

FIG. 5 shows a method 500 that includes the use of another server (Server 3) to authenticate the client. The method enables the integration of a single sign-on mechanism in the embodiments described herein. This mechanism may be implemented by, for example, OAuth, Auth0, SAML (Security Assertion Markup Language), or others. The third server may make use, for example, of challenge-response authentication to authenticate the client. Alternatively, well-known methods such as password-based authentication, PAKE (Password Authenticated Key Exchange), or methods without passwords such as, for example, WebAuthn can be used.

In step 510, the client requests the third server to authenticate the client. In one embodiment, this request may be preceded by a corresponding request from the client to the second server, which provides the client with information about the third server in order to put the client into the position to connect to the third server.

In step 520, the third server verifies the client, for example, in the context of the challenge-response authentication shown in FIG. 5. When using challenge-response authentication, the third server responds in step 520 with a challenge that includes, for example, a random number that is preferably encrypted using a password. In one embodiment, a password may be used that is stored by the third server for this purpose and is known to the client.

In step 530, the client responds with a response that is transmitted to the third server. The response can, for example, be generated from the random number by the client decrypting it using their password, modifying it by a predetermined function (for example, increment), and re-encrypting it using the password as the key.

In step 540, the third server validates the response of the client, for example, by decrypting the transmitted encrypted random number and, optionally, applying the predetermined function.

In step 550, the third server responds to the response of the client with a token that is transmitted to the client. The token is a digital object provided for use as a proof of identity by the client.

In step 560, the client transmits an access request to the second server. The access request includes said token.

In step 570, the second server verifies the token, by way of example making use of data relating to the client previously stored on the second server. This may include identifiers of the client.

The method 500 may be continued with method 700, which is described below.

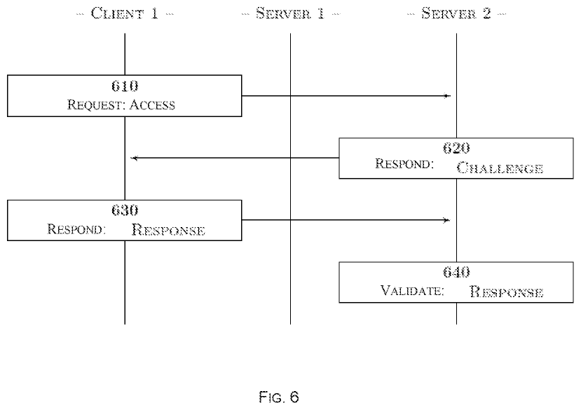

FIG. 6 shows a method 600 that is carried out without the involvement of a third server, and which is disclosed as an alternative to method 500.

In step 610, the client transmits an access request to the second server. Optionally, this request may include an identifier of the client or—as in the requests described thus far—may be subject to an authentication measure.

In step 620, the second server responds to the request with a challenge that is transmitted to the client.

In step 630, the client in turn responds to the challenge and transmits a response to the second server.

In step 640, the second server validates the response. The method 600 may be continued with the method 700 described below.

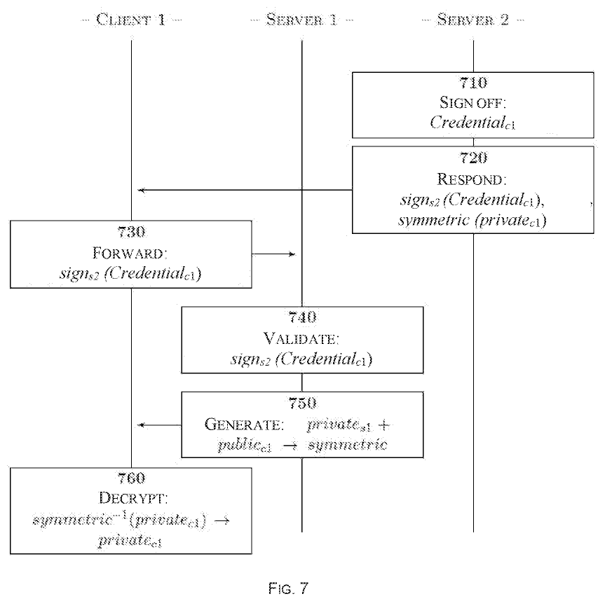

FIG. 7 shows a method 700 that brings about the securing of the credentials of the client to the symmetric key. The method 700 presupposes that one of the methods 500 and 600 has been carried out in preparation.

In step 710, the second server signs off on a credential of the client using the private key of the second server, the result being referred to here as signₛ₂(credential_{cf}). The credential is a data structure that may denote data or data locations, as well as may identify one or more users or clients. In addition, the data structure may contain definitions of what access rights the user(s)/client(s) have or should have to the data/data locations in question. As an alternative to identification of such users or clients, the data structure may contain or reference certificate chains. Certificate chains require a root certificate and may be used to verify an identity of a user or client. Signing off on such a credential can thus either be undertaken by the second server or delegated to certificate authorities. A certificate is a signed document that confirms the possibility to associate a digital signature (signature) with a particular party or entity, which in turn is authorized to perform certain actions. Such actions include the issuance of proofs of identity or authorization or the further delegation of such actions. Such a signed-off proof may be verified through the use of the public key associated with the private key that was used to generate the signature. By way of example, the first server uses the public key publicₛ₂ of the second server or the public key of a root certificate of the certificate chain.

In one embodiment, step 710 additionally comprises providing the signature with an expiration date. By way of example, the credential may be provided with a current timestamp and temporally valid duration.

In step 720, the second server transmits to the client the signed-off credential and the private key of the client encrypted with the symmetric key.

In step 730, the client forwards the signed-off credential to the first server and in this way requests the symmetric key.

In step 740, the first server validates the signed-off credential making use of the public key of the second server or a certificate chain. As discussed earlier, this public key may, for example, be obtained from a certificate authority or may have been provided by the client in step 730. In embodiments with expiry dates of the credential, the validation comprises a verification as to whether a difference between a current time stamp and a credential time stamp is greater than the time duration specified in the credential. If this is the case, the validation and the method 700 as a whole is terminated.

In step 750, the first server generates, as illustrated earlier, the symmetric key. Alternatively, the first server may retrieve the symmetric key locally; for this purpose, the client may further have communicated a corresponding identifier of the client to the first server in step 730. The symmetric key is transmitted to the client.

In step 760, the client decrypts the client private key encrypted with the symmetric key obtained in step 720.

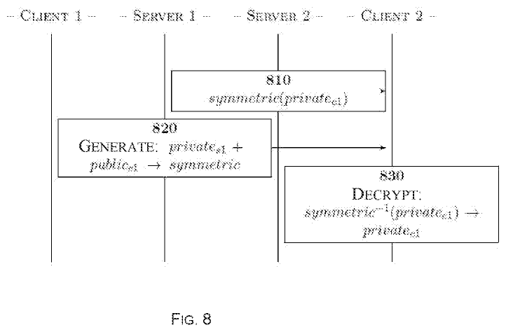

FIG. 8 shows a method 800 that enables the issuance and decryption of the private key of the client to a third party. Such a scenario may be necessary in a real-world application of the invention if a user is unable to perform any of the methods described herein on their own, or if the first client no longer exists but a new client has not yet been registered or could be registered. The method also thus enables access to user data in the event of death or a legal order to release user data.

The prerequisite for method 800 is the presentation of a legal or contractual order to the second server. This order is presented by a second client (client 2) and verified by the second server.

In step 810, after successful verification of the order, the second server transmits the private key stored there of the first client (Client 1) and the second client that is encrypted with the symmetric key. The order may be verified automatically or manually by an administrator of the second server. Alternatively, the order may comprise a signed-off credential that may be automatically validated by the second server using a public key of the second client.

In step 820, the first server generates the symmetric key from the private key of the first server and the public key of the first client or retrieves a previously stored symmetric key. The symmetric key is transmitted to the second client. Step 820, like step 810, occurs in response to a request from the second client that contains a credential, in particular a credential signed off by the second server, and which, as before by the second server, is verified by the first server. The credential may also be of a legal or contractual nature. In addition to a credential, the request from the second client may also contain an identifier of the client in order to put the first server in a position to identify the first client or its user. In one embodiment, step 820 may moreover comprise the transmission of a message to the first client and/or the second server. This message may include, for example, information relating to the credential and/or the second client from which the request for issuance of the symmetric key originated. The message may moreover include a request for the first client to consent to the issuance of the symmetric key; in such an embodiment, the first server may set a time duration within which it will wait for a response from the first client and may continue or suspend the issuance of the symmetric key if no response is received by the first server from the first client before expiration of the time duration.

In step 830, the second client decrypts the encrypted private key of the first client.

The embodiments described herein are supplemented by computer-readable media that store instructions that, when executed by one or more computers, such as the clients and servers explained above, carry out the elucidated methods. Similarly, embodiments of the invention also include the clients and servers themselves and the systems formed therefrom.

The measures disclosed herein for securing the availability of encryption keys, without compromising confidentiality, are for the most part automatic, not requiring a user intervention, and include the creation, protection, renewal, and restoration of private and public keys. At the same time, these keys can be used to continuously and also automatically encrypt and/or decrypt data for transmission and/or storage, digitally sign off on data, and/or digitally identify oneself. In this manner, the invention enables full end-to-end encryption, in which the ongoing storage of data on the target devices does not need to be unencrypted in plain text to guarantee data availability. The measures provide a high level of security through the methods described, including, in particular, regular renewal of the keys, which is not achieved by conventional approaches. The embodiments allow the measures to be adapted to the security requirements and IT infrastructure of the user or alternatively system administrators, by way of example through the distribution of the information required for restoration to any number of servers or the technical enforcement of specialized processes for restoration of keys.

1. A method for securing a private key of a first client, comprising:
a request made by the first client for a public key of a first server;
generation by the first client of a symmetric key from the private key of the first client and the public key of the first server, encryption of the private key of the first client with the symmetric key, and transmission of the encrypted private key of the first client to a second server; and
storage by the second server of the encrypted private key of the first client.

2. The method of claim 1, further comprising:
retrieval by the first client of the symmetric key from the first server and the encrypted private key of the first client from the second server;
generation by the first server of the symmetric key from a private key of the first server and a public key of the first client, and transmission of the symmetric key to the first client, wherein the private key of the first server is associated with the public key of the first server and the public key of the first client is associated with the private key of the first client; and
decryption by the first client of the encrypted private key of the first client using the symmetric key.

3. The method of claim 2, wherein the retrieval of the encrypted private key of the first client and/or of the symmetric key is carried out by encryption using a one-time password.

4. The method of claim 1, further comprising renewal of the encrypted private key of the first client, wherein the renewal comprises:
generation by the first client of a new private key and public key of the first client, and the request for a new public key of the first server from the first server;
generation by the first server of the new public key and a new private key of the first server, and transmission of the new public key of the first server to the first client;
generation by the first client of a new symmetric key from the new private key of the first client and the new public key of the first server, encryption of the new private key of the first client with the new symmetric key, and transmission of the new encrypted private key of the first client to the second server; and
storage by the second server of the new encrypted private key of the first client, and deletion of the previously stored encrypted private key of the first client.

5. The method of claim 4, further comprising:
wherein the renewal of the encrypted private key of the first client is carried out in response to a user request.

6. The method of claim 4, wherein the renewal of the encrypted private key of the first client is carried out automatically at regular intervals.

7. The method of claim 1, further comprising:
encryption by the first client of the first private key of the client with a password, and transmission of the first private key of the client encrypted with the password as well as a hash value generated from the password to the second server; and
storage by the second server of the first private key of the client encrypted with the password as well as a hash value of the hash value that has been transmitted.

8. The method of claim 7, further comprising:
transmission by the first client of the hash value of the password to the second server;
comparison by the second server of a hash value of the hash value that has been transmitted with the stored hash value of the first client, and transmission to the first client of the private key of the first client encrypted with the password; and decryption by the first client of the private key of the first client that has been transmitted with the password.

9. The method of claim 7, further comprising:
transmission by the first client of a request to replace the password to the second server;
transmission by the second server of a request to replace the password to the first server,
generation by the first server of the symmetric key from the private key of the first server and the public key of the first client, generation of a one-time password, encryption of the symmetric key with the one-time password, generation of a hash value of the one-time password, and transmission of the encrypted symmetric key and a hash value of the hash value of the one-time password to the second server, as well as of the one-time password to the first client;
transmission by the first client of a request for authentication of the first client to the second server, wherein the request contains a hash value of the one-time password;
comparison by the second server of the hash value of the first server with a hash value of the hash value of the one-time password transmitted by the first client, and transmission to the first client of the private key of the first client encrypted with the symmetric key as well as of the symmetric key encrypted with the one-time password; and decryption by the first client of the encrypted symmetric key with the one-time password, decryption of the encrypted private key of the first client with the symmetric key, encryption of the private key of the first client with a new password, and transmission of the private key of the first client encrypted with the new password and of a hash value of the new password to the second server.

10. The method of claim 1, further comprising:
transmission by the first client of an authentication request to a third server;
transmission by the third server of a challenge to the first client;
transmission by the first client of a response to the challenge to the third server;
validation by the third server of the response, and transmission of an access token to the first client;
transmission by the first client of an access request to the second server, wherein the access request includes the access token; and
verification by the second server of the access token.

11. The method of claim 1, further comprising:
transmission by the first client of an access request to the second server,
transmission by the second server of a challenge to the first client;
transmission by the first client of a response to the challenge to the second server; and
validation of the second server of the response based on the challenge.

12. The method of claim 10, further comprising:
signing off by the second server on a credential of the first client with the private key of the second server, and transmission of the signed-off credential and of the private key of the client encrypted with the symmetric key to the first client;
transmission by the first client of the signed-off credential to the first server;
validation by the first server of the signed-off credential of the first client by means of the certified public key of the second server, generation of the symmetric key from the private key of the first server and the public key of the first client, and transmission of the symmetric key to the first client; and
decryption by the first client of the encrypted private key of the first client with the symmetric key.

13. The method of claim 12, wherein the signing off on the credential of the first client comprises providing the signature of the credential with one or a plurality of timestamps, and wherein the validation of the signed-off credential is aborted when a time period defined by one or a plurality of timestamps has elapsed.

14. The method of claim 1, further comprising:
transmission by the second server of the private key of the first client encrypted with the symmetric key to a second client;
generation by the first server of the symmetric key from the private key of the first server and the public key of the first client, and transmission of the symmetric key to the second client; and
decryption by the second client of the private key of the first client using the symmetric key.

15. The system for securing a private key of a client, comprising:
a client, a first server, and a second server;
wherein the client is set up to request a public key of the first server;
wherein the first server is set up to transmit the public key of the first server to the client;
wherein the client is further set up to generate a symmetric key from the private key of the client and the public key of the first server, and to encrypt the private key of the client with the symmetric key, and to transmit the encrypted private key of the client to a second server; and
wherein the second server is set up to store the encrypted private key of the client.

16. The system of claim 15, wherein the client is further set up for retrieval of the symmetric key from the first server and the encrypted private key of the client from the second server, as well as for decryption of the encrypted private key of the client by means of the symmetric key.

17. (canceled)

18. The method of claim 11, further comprising:
signing off by the second server on a credential of the first client with the private key of the second server, and transmission of the signed-off credential and of the private key of the client encrypted with the symmetric key to the first client;
transmission by the first client of the signed-off credential to the first server;
validation by the first server of the signed-off credential of the first client by means of the certified public key of the second server, generation of the symmetric key from the private key of the first server and the public key of the first client, and transmission of the symmetric key to the first client; and
decryption by the first client of the encrypted private key of the first client with the symmetric key.

19. The method of claim 18, wherein the signing off on the credential of the first client comprises providing the signature of the credential with one or a plurality of timestamps, and wherein the validation of the signed-off credential is aborted when a time period defined by one or a plurality of timestamps has elapsed.
